(19) United States
(12) Patent Application Publication
(10) Pub. No.: US 2025/0184772 A1
(43) Pub. Date: Jun. 5, 2025

(54) INFORMATION TRANSMISSION METHOD AND APPARATUS, DEVICE, SYSTEM, AND STORAGE MEDIUM

(71) Applicant: VIVO MOBILE COMMUNICATION CO., LTD., Dongguan (CN)

(72) Inventors: Ang YANG, Dongguan (CN); Hao WU, Dongguan (CN); Tian XIE, Dongguan (CN); Peng SUN, Dongguan (CN)

(73) Assignee: VIVO MOBILE COMMUNICATION CO., LTD., Dongguan (CN)

(21) Appl. No.: 19/051,142

(22) Filed: Feb. 11, 2025

Related U.S. Application Data
(63) Continuation of application No. PCT/CN2023/111732, filed on Aug. 8, 2023.

(30) Foreign Application Priority Data
Aug. 12, 2022 (CN) 202210970370.2

(51) Int. Cl. H04W 24/02; H04B 7/0456

(52) U.S. Cl. CPC H04W 24/02; H04B 7/0456

(57) ABSTRACT

This application provides an information transmission method and apparatus, a device, a system, and a storage medium. The information transmission method includes: inputting, by a first device, first information into a first Artificial Intelligence (AI) module to obtain second information; and sending, by the first device, the second information to a second device. The second information is used for inputting the second information into a second AI module by the second device to obtain at least one of the first information or related information of the first information. Before the first AI module and the second AI module perform a first action, the first device and the second device align third information. The third information includes model information of at least one of the first AI module or the second AI module, and the first action includes at least one of the following: training, updating, or inference.

### CROSS-REFERENCE TO RELATED APPLICATIONS

This application is a continuation of International Application No. PCT/CN 2023/111732, filed on Aug. 8, 2023, which claims priority to Chinese Patent Application No. 202210970370.2, filed on Aug. 12, 2022. The entire contents of each of the above-referenced applications are expressly incorporated herein by reference.

### TECHNICAL FIELD

This application pertains to the field of communications technologies, and specifically, relates to an information transmission method and apparatus, a device, a system, and a storage medium.

### BACKGROUND

A network side may send a Channel State Information-Reference Signal (CSI-RS) to User Equipment (UE), so that the UE performs channel estimation. The UE performs channel estimation based on the CSI-RS, calculates corresponding channel information, and feeds back a Precoding Matrix Index (PMI) to the network side through a codebook. The network side combines channel information based on codebook information fed back by the UE, and the network side performs data precoding and multi-user scheduling based on this before next CSI reporting.

At present, CSI feedback can be increased by using an artificial intelligence model or a machine learning model. The specific process is as follows: jointly train/independently train all modules (such as an encoder and a decoder) of a model on a specific network node; deploy different modules in multiple different network nodes; and perform joint inference using the deployed modules of the model. However, because different network nodes may come from different vendors, all details of the model need to be informed to a target node during deployment of the model on different network nodes. Such a process may consequently lead to the problem of leakage of model information.

### SUMMARY

Embodiments of the application provide an information transmission method and apparatus, a device, a system, and a storage medium.

According to a first aspect, an information transmission method is provided, where the information transmission method includes: inputting, by a first device, first information into a first Artificial Intelligence (AI) module to obtain second information; and sending, by the first device, the second information to a second device, where the second information is used for inputting the second information into a second AI module by the second device to obtain the first information and/or related information of the first information; where before the first AI module and the second AI module perform a first action, the first device and the second device align third information; where the third information includes model information of the first AI module and/or the second AI module, and the first action includes at least one of the following: training, updating, and inference.

According a second aspect, an information transmission apparatus is provided, applied to a first device, where the information transmission apparatus includes a processing module and a sending module; where the processing module is configured to input first information into a first AI module to obtain second information; and the sending module is configured to send the second information obtained by the processing module to a second device, where the second information is used for being inputted into a second AI module by the second device to obtain first information and/or related information of the first information; where before the first AI module and the second AI module perform a first action, the first device and the second device align third information; where the third information includes model information of the first AI module and/or the second AI module, and the first action includes at least one of the following: training, updating, and inference.

According to a third aspect, an information transmission method is provided, where the method includes: receiving, by a second device, second information from a first device, where the second information is information obtained by the first device by inputting first information into a first AI module; and inputting, by the second device, the second information into a second AI module to obtain the first information and/or related information of the first information; where before the first AI module and the second AI module perform a first action, the first device and the second device align third information; where the third information includes model information of the first AI module and/or the second AI module, and the first action includes at least one of the following: training, updating, and inference.

According to a fourth aspect, an information transmission apparatus is provided, applied to a second device, where the information transmission apparatus includes a receiving module and a processing module; where the receiving module is configured to receive second information from a first device, where the second information is information obtained by the first device by inputting first information into a first AI module; and the processing module is configured to input the second information received by the receiving module into a second AI module to obtain the first information and/or related information of the first information; where before the first AI module and the second AI module perform a first action, the first device and the second device align third information; where the third information includes model information of the first AI module and/or the second AI module, and the first action includes at least one of the following: training, updating, and inference.

According to a fifth aspect, a communication device is provided, where the communication device includes a processor and a memory, where a program or instructions capable of running on the processor are stored in the memory, and when the program or the instructions are executed by the processor, the steps of the method according to the first aspect are implemented.

According to a sixth aspect, a communication device is provided, including a processor and a communication interface, where the processor is configured to input first information into a first AI module to obtain second information; and the communication interface is configured to send the second information to a second device, where the second information is used for being inputted into a second AI module by the second device to obtain first information and/or related information of the first information; where before the first AI module and the second AI module perform a first action, the first device and the second device align third information; where the third information includes model information of the first AI module and/or the second AI module, and the first action includes at least one of the following: training, updating, and inference.

According to a seventh aspect, a communication device is provided, where the communication device includes a processor and a memory, where a program or instructions capable of running on the processor are stored in the memory, and when the program or the instructions are executed by the processor, the steps of the method according to the third aspect are implemented.

According to an eighth aspect, a communication device is provided, including a processor and a communication interface, where the communication interface is configured to receive second information from a first device, where the second information is information obtained by the first device by inputting first information into a first AI module; and the processor is configured to input the second information into a second AI module to obtain the first information and/or related information of the first information; where before the first AI module and the second AI module perform a first action, the first device and the second device align third information; where the third information includes model information of the first AI module and/or the second AI module, and the first action includes at least one of the following: training, updating, and inference.

According to a ninth aspect, a communication system is provided, including a first device and a second device, where the first device can be configured to execute the steps of the information transmission method according to the first aspect, and the second device can be configured to execute the steps of the information transmission method according to the third aspect.

According to a tenth aspect, a readable storage medium is provided, where a program or instructions are stored in the readable storage medium, and in a case that the program or the instructions are executed by a processor, the steps of the method according to the first aspect are implemented, or the steps of the method according to the third aspect are implemented.

According to an eleventh aspect, a chip is provided, where the chip includes a processor and a communication interface, the communication interface is coupled to the processor, and the processor is configured to run a program or instructions to implement the method according to the first aspect or the method according to the third aspect.

According to a twelfth aspect, a computer program/program product is provided, where the computer program/program product is stored in a storage medium, and the computer program/program product is executed by at least one processor to implement the steps of the information transmission method according to the first aspect are implemented, or the steps of the information transmission method according to the third aspect.

In the embodiments of this application, the model related information of the first AI module and/or the second AI module is aligned in advance before training, updating, and/or inference performed by the first AI module and the second AI module. In this way, joint inference can be performed on information for the model distributed in different nodes, that is, when the first device performs inference on the first information by using the first AI module and the second device performs inference on the second information by using the second AI module, all details of the models do not need to be informed to the target node for joint inference, thereby ensuring the inference performance of the model and avoiding leakage of model information.

### BRIEF DESCRIPTION OF DRAWINGS

FIG. 1 is a schematic architectural diagram of a wireless communication system according to an embodiment of this application;

FIG. 2 is a schematic structural diagram of a neural network provided in the related art;

FIG. 3 is a schematic structural diagram of a neuron provided in the related art;

FIG. 4 is a flowchart of an information transmission method according to an embodiment of this application;

FIG. 5 is a first schematic structural diagram of an information transmission apparatus according to an embodiment of this application;

FIG. 6 is a second schematic structural diagram of an information transmission apparatus according to an embodiment of this application;

FIG. 7 is a schematic structural diagram of hardware of a communication device according to an embodiment of this application;

FIG. 8 is a schematic structural diagram of hardware of UE according to an embodiment of this application;

FIG. 9 is a first schematic structural diagram of a network-side device according to an embodiment of this application; and

FIG. 10 is a second schematic structural diagram of a network-side device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

The terms “first”, “second”, and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship.

It should be noted that technologies described in the embodiments of this application are not limited to a Long Term Evolution (LTE) or LTE-Advanced (LTE-A) system, and may also be applied to other wireless communication systems, for example, Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in the embodiments of this application are often used interchangeably, and the technology described herein may be used in the above-mentioned systems and radio technologies as well as other systems and radio technologies. In the following descriptions, a New Radio (NR) system is described for an illustration purpose, and NR terms are used in most of the following descriptions, although these technologies may also be applied to other applications than an NR system application, for example, the 6th Generation (6G) communication system.

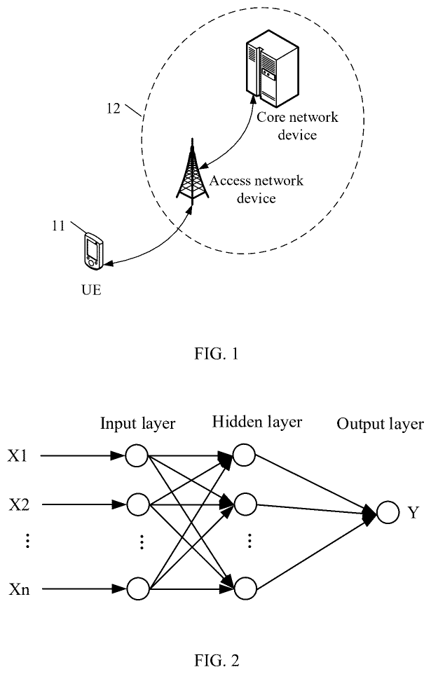

FIG. 1 is a block diagram of a wireless communication system to which the embodiments of this application are applicable. The wireless communication system includes UE 11 and a network-side device 12. The UE 11 may be a mobile phone, a tablet computer, a laptop computer, a personal digital assistant (PDA), a palmtop computer, a netbook, an ultra-mobile personal computer (UMPC), a Mobile Internet Device (MID), an augmented reality (AR)/virtual reality (VR) device, a robot, a wearable device, vehicle user equipment (VUE), pedestrian user equipment (PUE), a smart home device (a home device with wireless communication function, such as a refrigerator, a television, a washing machine, or a furniture), a game console, a personal computer (PC), a teller machine, a self-service machine, or the like. The wearable device includes: a smart watch, a wrist band, smart earphones, smart glasses, smart jewelry (smart bracelet, smart wristband, smart ring, smart necklace, smart anklet, smart ankle bracelet, or the like), smart wristband, smart clothing, and the like. It should be noted that a specific type of the UE 11 is not limited in the embodiments of this application. The network-side device 12 may include an access network device or a core network device, where the access network device 12 may also be referred to as a radio access network device, a Radio Access Network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the art. Provided that a same technical effect is achieved, the base station is not limited to a specific technical term. It should be noted that in the embodiments of this application, the base station in the NR system is merely used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), a Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, a core network device in an NR system is used as an example for description, and a specific type of the core network device is not limited.

The following describes some concepts and/or terms involved in an information transmission method and apparatus, a device, a system, and a storage medium provided in the embodiments of the application.

### 1. Artificial Intelligence (AI)

AI allows integration of artificial intelligence into wireless communication networks, and it is an important task for future wireless communication networks to significantly improve technical indicators such as throughput, delay, and user capacity. AI modules are implemented in a variety of manners, such as neural network, decision tree, support vector machine, and Bayesian classifier. The embodiments of the application use a neural network as an example for description, but do not limit specific types of AI modules.

For example, as shown in FIG. 2, FIG. 2 is a schematic diagram of a neural network. The neural network includes an input layer, hidden layers, and an output layer, where X1, X2, . . . , Xn are inputs and Y is an output.

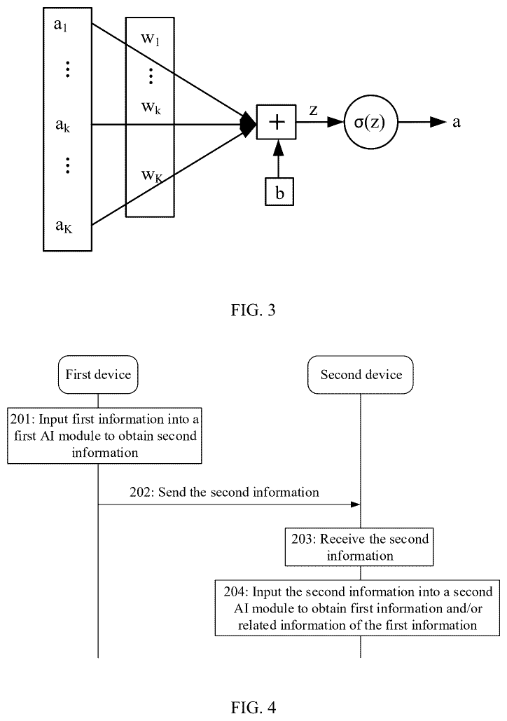

The neural network is composed of neurons. As shown in FIG. 3, FIG. 3 is a schematic diagram of a neuron. a₁, a₂, . . . , a_{K} are inputs, w is a weight (a multiplicative coefficient), and b is a bias (an additive coefficient). z=a₁w₁+ . . . +aₖwₖ+ . . . +a_{K}w_{K}+b; and σ(z) is an activation function. Generally, the activation function includes Sigmoid, tan h, ReLU (Rectified Linear Unit, linear rectifier function, rectifier linear unit), and so on.

Parameters of the neural network are optimized by using a gradient optimization algorithm. The gradient optimization algorithm is a type of algorithm that minimizes or maximizes an objective function (also called a loss function), and the objective function is a mathematical combination of model parameters and data. For example, data X and its corresponding label Y are given to construct a neural network model f(·). With this model, a predicted output f(x) can be obtained based on the input x, and a difference (f(x)-Y) between the predicted value and a real value can be calculated, which is the loss function. A suitable W, b found minimizes a value of the loss function, and a smaller loss value indicates that the model is closer to the real situation.

At present, a common optimization algorithm is based on BP (error Back Propagation, error back propagation). The basic idea of the BP algorithm is that a learning process includes two processes: forward propagation of signals and the back propagation of errors. In the forward propagation, input samples are transmitted from the input layer, processed layer by layer by each hidden layer, and then transmitted to the output layer. If an actual output of the output layer is not consistent with an expected output, it proceeds to the backward propagation stage of errors. Error back propagation means that output errors are transmitted back to the input layer through the hidden layers layer by layer in a specific form, and the errors are distributed to all units at each layer, so as to obtain an error signal of each layer unit. The error signal is used as a basis for rectifying a weight of each unit. This process of adjusting the weight of each layer for forward propagation of signals and back propagation of errors is performed repeatedly. The process of constantly adjusting weights is also the learning and training process of the network. This process continues until the errors of network outputs are reduced to an acceptable level, or until the preset number of learning times is reached.

Common optimization algorithms include gradient descent, Stochastic Gradient Descent (SGD), mini-batch gradient descent, momentum, Nesterov (inventor's name, for example, being random gradient decrease of a driving amount), Adagrad (ADAptive GRADient descent, adaptive gradient descent), Adadelta, RMSprop (root mean square prop, root mean square prop), Adam (Adaptive Moment Estimation), and the like.

For these optimization algorithms used in back propagation of errors, a derivative/deflection of a current neuron is calculated based on the error/loss obtained by the loss function, and the influence of the learning rate and the previous gradient/derivative/deflection is considered, so as to obtain a gradient, and then the gradient is transmitted to an upper level.

### 2. Channel State Information (CSI) Feedback

Accurate CSI is very important for a channel capacity. Especially for a multi-antenna system, a transmit end can optimize signal transmission based on the CSI to make it more match a channel state. For example, a Channel Quality Indicator (CQI) can be used for selecting an appropriate Modulation And Coding Scheme (MCS) to implement link adaptation. The Precoding Matrix Indicator (PMI) can be used to implement eigen beamforming to maximize a strength of a received signal, or to suppress interference (such as inter-cell interference, multi-user interference, and the like). Therefore, since the Multi-Input Multi-Output (MIMO) technology was put forward, CSI acquisition has always been a research hotspot.

Generally, a base station sends a CSI-RS on some time-frequency resources in a slot, the UE performs channel estimation based on the CSI-RS, calculates channel information on this slot, and feeds back a PMI to the base station through a codebook, and the base station combines channel information based on codebook information fed back by the UE, so that the base station can perform data precoding and multi-user scheduling based on such information before the next CSI reporting.

To further reduce CSI feedback overheads, the UE may change PMI reporting per sub-band to PMI reporting per delay. Because channels in delay domain are more concentrated, the PMI of all sub-bands can be approximately represented with PMI with less delay, that is, information in the delay domain is compressed before reporting.

Similarly, to reduce the overheads, the base station can pre-code the CSI-RS in advance and send a coded CSI-RS to a terminal. The UE detects a channel corresponding to the coded CSI-RS, and the UE merely needs to select several ports with higher strength from ports indicated by the network side and report corresponding coefficients of these ports.

The following describes the information transmission method provided in the embodiments of this application through specific embodiments and application scenarios thereof with reference to the accompanying drawings.

At present, for AI/ML at the air interface, models are trained on multiple network nodes separately, and the trained models also need to be jointly used for inference. For enhancement of CSI feedback by AI/ML, the following steps need to be performed: (1) jointly train all modules (namely an encoder and a decoder) of a model on a specific network node; (2) deploy different modules on multiple different network nodes; and (3) perform joint inference on the deployed modules of the model.

However, different network nodes may come from different vendors (such as base stations and UEs usually belong to different vendors), and some vendors are unwilling to disclose details of models to other vendors; however, in some use cases (such as CSI compression), models distributed on multiple network nodes are required to conduct joint inference, and therefore, all the details of the models need to be informed to a target node during deployment of the model on different network nodes. Such a process may consequently lead to the problem of leakage of model information.

In the embodiments of this application, the model related information of the first AI module and/or the second AI module is aligned in advance before training, updating, and/or inference is performed by the first AI module and the second AI module. In this way, when joint inference is performed on information for the model distributed in different nodes, all the details of the model do not need to be informed to the target node for joint inference, thereby ensuring the inference performance of the model and avoiding leakage of model information.

An embodiment of the application provides an information transmission method, and FIG. 4 is a flowchart of an information transmission method according to an embodiment of this application. As shown in FIG. 4, the information transmission method provided in this embodiment of this application may include the following steps 201 to 204.

Step 201: A first device inputs first information into a first AI module to obtain second information.

In this embodiment of this application, the first device may perform inference on the first information by using the first AI module to obtain the second information.

For example, in this embodiment of this application, the first information includes at least one of the following: channel information (for example, CSI) and beam quality information.

For example, in this embodiment of this application, the second information includes at least one of PMI, predicted beam information or beam indication.

For example, in this embodiment of this application, the first information includes channel information, and the second information is PMI. In some embodiments, the first information includes beam quality, and the second information is predicted beam information or beam indication.

Step 202: The first device sends the second information to a second device.

In this embodiment of this application, the second information is used for being inputted into a second AI module by the second device to obtain first information and/or related information of the first information. That is, the second device may perform inference on the second information by using the second AI module, to obtain the related information of the first information and/or restore the first information.

In this embodiment of this application, before the first AI module and the second AI module perform a first action, the first device and the second device align third information; where the third information includes model information of the first AI module and/or the second AI module, and the first action includes at least one of the following: training, updating, and inference.

For example, in this embodiment of this application, the first device may be a network-side device or UE; and the second device may be a network-side device or UE.

For example, in this embodiment of this application, the first device is a network-side device, and the second device is UE. In some embodiments, the first device is UE, and the second device is a network-side device. In some embodiments, the first device and the second device are different nodes (such as base stations and network elements) on the network side. In some embodiments, the first device and the second device are different UE nodes.

For example, in this embodiment of this application, the related information of the first information may include at least one of the following: precoding matrix, decomposition matrix or vector of a channel, inverse matrix of channel matrix, inverse matrix or inverse vector of the decomposition matrix or vector of the channel, channel information in transform domain, rank, rank index, layer, layer index, channel quality, channel signal-to-noise ratio, identifier of an optional beam, and beam quality of the optional beam.

For example, in this embodiment of this application, in the decomposition matrix or vector of the channel, a specific method of decomposition is any one of the following: singular value decomposition, eigenvalue decomposition, and triangular decomposition.

For example, in this embodiment of this application, the transform domain includes at least one of the following: spatial domain, frequency domain, time domain, delay domain, Doppler domain, and the like. In some embodiments, the transform domain includes a combination domain of at least two of the spatial domain, the frequency domain, the time domain, the delay domain, and the Doppler domain. For example, the delay domain and the Doppler domain are combined into a delay-Doppler domain.

For example, in this embodiment of this application, the first AI module and/or the second AI module are obtained based on at least one of the following:
being obtained through training by the first device based on target information from the second device or other network elements; and
being obtained through training by the second device based on target information from the first device or other network elements.

In this embodiment of this application, the target information includes at least one first information related to the first action of the AI module and at least one second information corresponding to the at least one first information.

It can be understood that in the training phase of the first AI module and the second AI module, the first device or other network elements send (a large amount of) first information and corresponding second information to the second device, or the second device or other network elements send (a large amount of) first information and corresponding second information to the first device.

It should be noted that the first information is a specific type of information, and the at least one first information refers to at least one value or at least one parameter of this type of information. The same holds true for the second message.

For example, in this embodiment of this application, the first AI module and/or the second AI module are updated or adjusted according to at least one of the following:
performing updating or adjustment by the first device based on the target information from the second device or other network elements; and
performing updating or adjustment by the second device based on the target information from the first device or other network elements.

It can be understood that for updating or adjustment of the first AI module and the second AI module, the first device or other network elements send (a large amount of) first information and corresponding second information to the second device, or the second device or other network elements send (a large amount of) first information and corresponding second information to the first device.

In this embodiment of this application, the first device and the second device may perform interaction of model input and output data to train the first AI module and/or the second AI module, or to update/adjust the first AI module and/or the second AI module, so as to use models distributed on different nodes to perform inference on information.

For example, in this embodiment of this application, the third information includes at least one of the following: a structural feature of a model, a payload quantization method of the model, and estimation accuracy or output accuracy of the model.

It can be understood that the first device and the second device may align all or part of the structural features of the first AI module and/or the second AI module; and/or, the first device and the second device may align the payload quantization method of the first AI module and/or the second AI module; and/or, the first device and the second device may align the estimation accuracy/output accuracy of the first AI module and/or the second AI module.

For example, in this embodiment of this application, the structural features of the model include at least one of the following: a model structure, a basic structural feature of the model, a structural feature of a model sub-module, the number of model layers, the number of neurons in the model, a model size, model complexity, and a quantization parameter of a model parameter.

It can be understood that the first device and the second device align the structural features of the first AI module and/or the second AI module, so that the first device and the second device use a same model structure. For example, model structures of the UE and the base station for generating Uplink Control Information (UCI) are consistent, that is, the third information directly indicates that the model structures of the UE and the base station are the same.

For example, in this embodiment of this application, the basic structural feature of the model includes at least one of the following: whether a fully connected structure is included, whether a convolution structure is included, whether a Long-Short Term Memory (LSTM) structure is included, whether an attention structure is included, and whether a residual structure is included.

For example, in this embodiment of this application, the number of neurons in the model includes at least one of the following: the number of fully connected neurons, the number of convolution neurons, the number of memory neurons, the number of attention neurons, and the number of residual neurons.

For example, in this embodiment of this application, the number of neurons in the model includes at least one of the following: the number of neurons of all types, the number of neurons of a single type, the number of neurons of an entire model, and the number of neurons of a single layer or several layers.

It should be noted that the number of neurons of all types and the number of neurons of a single type can be understood as the number of neurons of one type, and the number of neurons of the entire model and the number of neurons of a single layer or several layers can be understood as the number of neurons of one type. For example, the number of neurons of all types is combined with the number of neurons of the entire model, that is, the first device and the second device need to align the number of neurons of all types and the entire model. In some embodiments, for example, the number of neurons of a single type is combined with the number of neurons of a single layer or several layers, that is, the first device and the second device need to align neurons of a single type and single layer, such as fully connected neurons of the third layer.

For example, in this embodiment of this application, the quantization parameter of the model parameter includes at least one of the following: a quantization mode of the model parameter and the number of quantization bits of a single neuron parameter; where the quantization mode of the model parameter includes at least one of the following: a uniform quantization mode, a non-uniform quantization mode, a weight sharing quantization mode or grouping quantization mode, a parameter coding quantization mode, a transform domain quantization mode, and a product quantization mode.

It should be noted that the weight sharing quantization mode or grouping quantization mode can be understood as: AI parameters are divided into multiple sets, and elements in each set share one value.

The parameter coding quantization mode (parameter coding method) can be understood as: coding floating point numbers, which, for example, includes at least one of the following: lossy coding, lossless coding such as Huffman coding, and the like.

The transform domain quantization mode (transform domain quantization method) can be understood as: transforming the floating point number to another domain, such as frequency domain, S domain, or Z domain, and performing at least one of the foregoing quantization operations, and then inversely transforming them back.

Product quantization can be understood as dividing the floating point number into multiple subspaces, and performing at least one of the foregoing quantization operation on each subspace.

For example, in this embodiment of this application, the payload quantization method includes at least one of the following: a quantization mode, dimensions of features before and after quantization, and a quantization method used during quantization.

It should be noted that the payload quantization method here refers to how the model transforms output floating point number type features into binary type feedback information suitable for transmission, which is different from the quantization of model parameters in the structural features of the model.

For example, in this embodiment of this application, the foregoing quantization mode may be configured through the third information, or may be configured through a codebook (that is, what quantization mode is used in an associated codebook, so what quantization mode is used for training here), or may be determined based on a CSI report configuration (that is, what quantization mode is used for the CSI report configuration, so what quantization mode is used for training here). In other words, the codebook or CSI report configuration belongs to the third information.

For example, in this embodiment of this application, the quantization method used during quantization includes at least one of the following: codebook content and a codebook usage method need to be synchronized when a codebook is used for quantization, and a quantization rule needs to be synchronized when a specific rule is used for quantization.

For example, the codebook content is the matrix itself. For example, five floating point numbers are quantized into 10 bits, to construct one codebook of [5,2\hat{ }10], that is, a matrix with 5 rows and 2\hat{ }10 columns, and content of the codebook is the matrix itself.

For another example, codebook quantization: for floating point number vectors with a length of 10 and a value range of [0,1], the first five floating point numbers are selected from a column of vectors with a smallest error in a codebook of [5,2\hat{ }10] as a quantization result, and the last five floating point numbers are selected from a column of vectors with a smallest error in a codebook of [5,2\hat{ }15] as a quantization result. Finally, a serial number of a column corresponding to a selected quantization result in the codebook is used as binary payload information for feedback.

For example, in this embodiment of this application, the quantization rule includes at least one of the following: N quantization ranges, and a quantization mode, where N is a positive integer; and the quantization mode includes at least one of the following: a uniform quantization mode, a non-uniform quantization mode, a weight sharing quantization mode or grouping quantization mode, a parameter coding quantization mode, a transform domain quantization mode, and a product quantization mode.

It should be noted that for the description of various quantization modes here, reference may be made to the descriptions in the foregoing embodiments, and details are not repeated herein.

For example, in N quantization ranges, N1 floating point numbers in a single quantization range are quantized into N2 bits.

For another example, a quantization rule is that: for floating point number vectors with a length of 10 and a value range of [0,1], the first five floating point numbers are uniformly quantized with 2 bits each, and the last five floating point numbers are uniformly quantized with 3 bits each. Finally, a serial number of a selected range is used as binary payload information for feedback.

For example, in this embodiment of this application, during synchronization of the codebook content and the codebook usage method and/or during synchronization of the quantization rule, the synchronization method includes any one of the following: selecting a set number representing a selected method for feedback during synchronization from a predefined set of methods, and directly sending the codebook content.

For example, in this embodiment of this application, a manner of aligning the third information by the first device and the second device includes at least one of the following:
the first device or other network elements simultaneously send the third information when sending target information to the second device;
the second device or other network elements simultaneously send the third information when sending target information to the first device;
the first device or other network elements send the third information before the first device or other network elements send the target information to the second device;
the second device or other network elements send the third information before the second device or other network elements send the target information to the first device;
the second device sends the third information when the second device requests the target information;
the first device sends the third information when the first device requests the target information;
the first device or other network elements send acknowledgment information and send the third information when the second device requests the target information, where the acknowledgment information is used to indicate that a request of the second device is agreed; and
the second device or other network elements send acknowledgment information and send the third information when the first device requests the target information, where the acknowledgment information is used to indicate that a request of the first device is agreed; where
the target information includes at least one first information related to the first action of the AI module and at least one second information corresponding to the at least one first information.

For example, in this embodiment of this application, the second device or other network elements send the target information after the first device sends the acknowledgment information of the third information.

For example, in this embodiment of this application, the first device or other network elements send the target information after the second device sends the acknowledgment information of the third information.

In this embodiment of this application, the process does not involve interaction of all model implementation details.

For example, in this embodiment of this application, a manner of aligning the third information by the first device and the second device includes at least one of the following:
after a device receiving the third information sends acknowledgment information for the third information, the first AI module and/or the second AI module is able to use a model associated with the third information;
after a device receiving the third information sends acknowledgment information for the third information and a first duration elapses, the first AI module and/or the second AI module is able to use a model associated with the third information; and
after a first duration following a sending time or receiving time of the third information elapses, the first AI module and/or the second AI module is able to use a model associated with the third information.

For example, in this embodiment of this application, the first duration is determined based on any one of the following: being carried by the third information, being carried by the acknowledgment information for the third information, being carried by other associated information or signaling of the third information, being specified by a protocol, and being determined based on a capability of the first device or the second device.

Step 203: The second device receives the second information from the first device.

In this embodiment of this application, the second information is information obtained by the first device by inputting first information into a first AI module.

Step 204: The second device inputs the second information into a second AI module to obtain the first information and/or related information of the first information.

According to the information transmission method in this embodiment of this application, the model related information of the first AI module and/or the second AI module is aligned in advance before training, updating, and/or inference performed by the first AI module and the second AI module. In this way, joint inference can be performed on information for the model distributed in different nodes, that is, when the first device performs inference on the first information by using the first AI module and the second device performs inference on the second information by using the second AI module, all details of the models do not need to be informed to the target node for joint inference, thereby ensuring the inference performance of the model and avoiding leakage of model information.

For the information transmission method provided in this embodiment of this application, the execution subject may be an information transmission apparatus. In the embodiments of this application, the information transmission apparatus provided by the embodiments of this application is described by using the information transmission method being executed by the first device and the second device as an example.

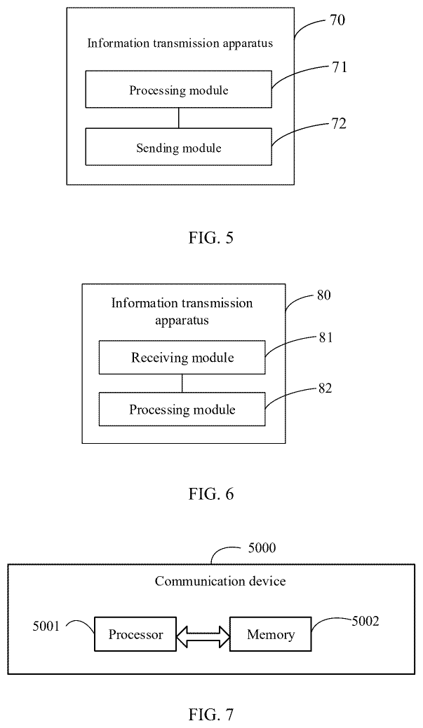

FIG. 5 is a possible structural diagram of an information transmission apparatus involved in the embodiments of this application, and the information transmission apparatus is applied to a first device. As shown in FIG. 5, the information transmission apparatus 70 may include a processing module 71 and a sending module 72.

The processing module 71 is configured to first information into a first AI module to obtain second information. The sending module 72 is configured to send the second information obtained by the processing module 71 to a second device, where the second information is used for being inputted into a second AI module by the second device to obtain first information and/or related information of the first information; where before the first AI module and the second AI module perform a first action, the first device and the second device align third information; where the third information includes model information of the first AI module and/or the second AI module, and the first action includes at least one of the following: training, updating, and inference.

According to the information transmission apparatus in this embodiment of this application, the model related information of the first AI module and/or the second AI module is aligned in advance before training, updating, and/or inference performed by the first AI module and the second AI module. In this way, joint inference can be performed on information for the model distributed in different nodes, that is, when the information transmission apparatus performs inference on the first information by using the first AI module and the second device performs inference on the second information by using the second AI module, all details of the models do not need to be informed to the target node for joint inference, thereby ensuring the inference performance of the model and avoiding leakage of model information.

In a possible implementation, the first information includes at least one of the following: channel information and beam quality information. The second information includes at least one of the following: PMI, predicted beam information, or beam indication.

In a possible implementation, the first AI module and/or the second AI module are obtained based on at least one of the following:
being obtained through training by the first device based on target information from the second device or other network elements; and
being obtained through training by the second device based on target information from the first device or other network elements; or
the first AI module and/or the second AI module are updated or adjusted according to at least one of the following:
performing updating or adjustment by the first device based on the target information from the second device or other network elements; and
performing updating or adjustment by the second device based on the target information from the first device or other network elements; where
the target information includes at least one first information related to the first action of the AI module and at least one second information corresponding to the at least one first information.

In a possible implementation, the third information, for example, includes at least one of the following: a structural feature of a model, a payload quantization method of the model, and estimation accuracy or output accuracy of the model.

In a possible implementation, the structural features of the model include at least one of the following: a model structure, a basic structural feature of the model, a structural feature of a model sub-module, the number of model layers, the number of neurons in the model, a model size, model complexity, and a quantization parameter of a model parameter.

In a possible implementation, the basic structural feature of the model includes at least one of the following: whether a fully connected structure is included, whether a convolution structure is included, whether an LSTM structure is included, whether an attention structure is included, and whether a residual structure is included.

In a possible implementation, the number of neurons in the model includes at least one of the following: the number of fully connected neurons, the number of convolution neurons, the number of memory neurons, the number of attention neurons, and the number of residual neurons; and/or the number of neurons in the model includes at least one of the following: the number of neurons of all types, the number of neurons of a single type, the number of neurons of an entire model, and the number of neurons of a single layer or several layers.

In a possible implementation, the quantization parameter of the model parameter includes at least one of the following: a quantization mode of the model parameter and the number of quantization bits of a single neuron parameter; and the quantization mode of the model parameter includes at least one of the following: a uniform quantization mode, a non-uniform quantization mode, a weight sharing quantization mode or grouping quantization mode, a parameter coding quantization mode, a transform domain quantization mode, and a product quantization mode.

In a possible implementation, the payload quantization method includes at least one of the following: a quantization mode, dimensions of features before and after quantization, and a quantization method used during quantization.

In a possible implementation, the quantization method used during quantization includes at least one of the following: codebook content and a codebook usage method need to be synchronized when a codebook is used for quantization, and a quantization rule needs to be synchronized when a specific rule is used for quantization.

In a possible implementation, the quantization rule includes at least one of the following: N quantization ranges, and a quantization mode, where Nis a positive integer; and the quantization mode includes at least one of the following: a uniform quantization mode, a non-uniform quantization mode, a weight sharing quantization mode or grouping quantization mode, a parameter coding quantization mode, a transform domain quantization mode, and a product quantization mode.

In a possible implementation, during synchronization of the codebook content and the codebook usage method and/or during synchronization of the quantization rule, the synchronization method includes any one of the following: selecting a set number representing a selected method for feedback during synchronization from a predefined set of methods, and directly sending the codebook content.

In a possible implementation, a manner of aligning the third information by the first device and the second device includes at least one of the following:
the first device or other network elements simultaneously send the third information when sending target information to the second device;
the second device or other network elements simultaneously send the third information when sending target information to the first device;
the first device or other network elements send the third information before the first device or other network elements send the target information to the second device;
the second device or other network elements send the third information before the second device or other network elements send the target information to the first device;
the second device sends the third information when the second device requests the target information;
the first device sends the third information when the first device requests the target information;
the first device or other network elements send acknowledgment information and send the third information when the second device requests the target information, where the acknowledgment information is used to indicate that a request of the second device is agreed; and
the second device or other network elements send acknowledgment information and send the third information when the first device requests the target information, where the acknowledgment information is used to indicate that a request of the first device is agreed; where
the target information includes at least one first information related to the first action of the AI module and at least one second information corresponding to the at least one first information.

In a possible implementation, the second device or other network elements send the target information after the first device sends the acknowledgment information of the third information; and/or the first device or other network elements send the target information after the second device sends the acknowledgment information of the third information.

In a possible implementation, a manner of aligning the third information by the first device and the second device includes at least one of the following:
after a device receiving the third information sends acknowledgment information for the third information, the first AI module and/or the second AI module is able to use a model associated with the third information;
after a device receiving the third information sends acknowledgment information for the third information and a first duration elapses, the first AI module and/or the second AI module is able to use a model associated with the third information; and
after a first duration following a sending time or receiving time of the third information elapses, the first AI module and/or the second AI module is able to use a model associated with the third information.

In a possible implementation, the first duration is determined based on any one of the following: being carried by the third information, being carried by the acknowledgment information for the third information, being carried by other associated information or signaling of the third information, being specified by a protocol, and being determined based on a capability of the first device or the second device.

The information transmission apparatus provided in this embodiment of this application can implement the processes implemented by the first device in the foregoing method embodiment, with the same technical effects achieved. To avoid repetition, details are not described herein again.

FIG. 6 is a possible structural diagram of an information transmission apparatus involved in the embodiments of this application, and the information transmission apparatus is applied to a second device. As shown in FIG. 6, the information transmission apparatus 80 may include a receiving module 81 and a processing module 82.

The receiving module 81 is configured to receive second information from a first device, where the second information is information obtained by the first device by inputting first information into a first AI module; and the processing module 82 is configured to input the second information received by the receiving module 81 into a second AI module to obtain the first information and/or related information of the first information; where before the first AI module and the second AI module perform a first action, the first device and the second device align third information; where the third information includes model information of the first AI module and/or the second AI module, and the first action includes at least one of the following: training, updating, and inference.

According to the information transmission apparatus in this embodiment of this application, the model related information of the first AI module and/or the second AI module is aligned in advance before training, updating, and/or inference performed by the first AI module and the second AI module. In this way, joint inference can be performed on information for the model distributed in different nodes, that is, when the first device performs inference on the first information by using the first AI module and the information transmission apparatus performs inference on the second information by using the second AI module, all details of the models do not need to be informed to the target node for joint inference, thereby ensuring the inference performance of the model and avoiding leakage of model information.

In a possible implementation, the first information includes at least one of the following: channel information and beam quality information. The second information includes at least one of the following: PMI, predicted beam information, or beam indication.

In a possible implementation, the first AI module and/or the second AI module are obtained based on at least one of the following:
being obtained through training by the first device based on target information from the second device or other network elements; and
being obtained through training by the second device based on target information from the first device or other network elements; or
the first AI module and/or the second AI module are updated or adjusted according to at least one of the following:
performing updating or adjustment by the first device based on the target information from the second device or other network elements; and
performing updating or adjustment by the second device based on the target information from the first device or other network elements; where
the target information includes at least one first information related to the first action of the AI module and at least one second information corresponding to the at least one first information.

In a possible implementation, the third information, for example, includes at least one of the following: a structural feature of a model, a payload quantization method of the model, and estimation accuracy or output accuracy of the model.

In a possible implementation, the structural features of the model include at least one of the following: a model structure, a basic structural feature of the model, a structural feature of a model sub-module, the number of model layers, the number of neurons in the model, a model size, model complexity, and a quantization parameter of a model parameter.

In a possible implementation, the basic structural feature of the model includes at least one of the following: whether a fully connected structure is included, whether a convolution structure is included, whether an LSTM structure is included, whether an attention structure is included, and whether a residual structure is included.

In a possible implementation, the number of neurons in the model includes at least one of the following: the number of fully connected neurons, the number of convolution neurons, the number of memory neurons, the number of attention neurons, and the number of residual neurons; and/or the number of neurons in the model includes at least one of the following: the number of neurons of all types, the number of neurons of a single type, the number of neurons of an entire model, and the number of neurons of a single layer or several layers.

In a possible implementation, the quantization parameter of the model parameter includes at least one of the following: a quantization mode of the model parameter and the number of quantization bits of a single neuron parameter; and the quantization mode of the model parameter includes at least one of the following: a uniform quantization mode, a non-uniform quantization mode, a weight sharing quantization mode or grouping quantization mode, a parameter coding quantization mode, a transform domain quantization mode, and a product quantization mode.

In a possible implementation, the payload quantization method includes at least one of the following: a quantization mode, dimensions of features before and after quantization, and a quantization method used during quantization.

In a possible implementation, the quantization method used during quantization includes at least one of the following: codebook content and a codebook usage method need to be synchronized when a codebook is used for quantization, and a quantization rule needs to be synchronized when a specific rule is used for quantization.

In a possible implementation, the quantization rule includes at least one of the following: N quantization ranges, and a quantization mode, where Nis a positive integer; and the quantization mode includes at least one of the following: a uniform quantization mode, a non-uniform quantization mode, a weight sharing quantization mode or grouping quantization mode, a parameter coding quantization mode, a transform domain quantization mode, and a product quantization mode.

In a possible implementation, during synchronization of the codebook content and the codebook usage method and/or during synchronization of the quantization rule, the synchronization method includes any one of the following: selecting a set number representing a selected method for feedback during synchronization from a predefined set of methods, and directly sending the codebook content.

In a possible implementation, a manner of aligning the third information by the first device and the second device includes at least one of the following:
the first device or other network elements simultaneously send the third information when sending target information to the second device;
the second device or other network elements simultaneously send the third information when sending target information to the first device;
the first device or other network elements send the third information before the first device or other network elements send the target information to the second device;
the second device or other network elements send the third information before the second device or other network elements send the target information to the first device;
the second device sends the third information when the second device requests the target information;
the first device sends the third information when the first device requests the target information;
the first device or other network elements send acknowledgment information and send the third information when the second device requests the target information, where the acknowledgment information is used to indicate that a request of the second device is agreed; and
the second device or other network elements send acknowledgment information and send the third information when the first device requests the target information, where the acknowledgment information is used to indicate that a request of the first device is agreed; where
the target information includes at least one first information related to the first action of the AI module and at least one second information corresponding to the at least one first information.

In a possible implementation, the second device or other network elements send the target information after the first device sends the acknowledgment information of the third information; and/or, the first device or other network elements send the target information after the second device sends the acknowledgment information of the third information.

In a possible implementation, a manner of aligning the third information by the first device and the second device includes at least one of the following:
after a device receiving the third information sends acknowledgment information for the third information, the first AI module and/or the second AI module is able to use a model associated with the third information;
after a device receiving the third information sends acknowledgment information for the third information and a first duration elapses, the first AI module and/or the second AI module is able to use a model associated with the third information; and
after a first duration following a sending time or receiving time of the third information elapses, the first AI module and/or the second AI module is able to use a model associated with the third information.

In a possible implementation, the first duration is determined based on any one of the following: being carried by the third information, being carried by the acknowledgment information for the third information, being carried by other associated information or signaling of the third information, being specified by a protocol, and being determined based on a capability of the first device or the second device.

The information transmission apparatus provided in this embodiment of this application can implement the processes implemented by the second device in the foregoing method embodiment, with the same technical effects achieved. To avoid repetition, details are not described herein again.

The information transmission apparatus in this embodiment of this application may be UE, such as UE with an operating system, or a component in the UE, such as an integrated circuit or a chip. The UE may be a terminal or other devices than the terminal. For example, the UE may include, but is not limited to, the types of the UE 11 listed above, and other devices may be a server, a Network Attached Storage (NAS), and the like. This is not limited in the embodiments of this application.

For example, as shown in FIG. 7, an embodiment of this application further provides a communication device 5000, including a processor 5001 and a memory 5002. A program or instructions capable of running on the processor 5001 are stored in the memory 5002. For example, when the communication device 5000 is a first device and when the program or the instructions are executed by the processor 5001, the steps of the foregoing embodiments of the method on the first device side are implemented, with the same technical effects achieved. To avoid repetition, details are not described herein again. When the communication device 5000 is a second device and when the program or the instructions are executed by the processor 5001, the steps of the foregoing embodiments of the method on the second device side are implemented, with the same technical effects achieved. To avoid repetition, details are not described herein again.

It should be noted that in this embodiment of this application, the first device may be UE or a network-side device; and the second device may be a network-side device or UE. In the following embodiments, the hardware structures of the UE and the network-side device are described.

An embodiment of this application further provides UE, including a processor and a communication interface. The processor is configured to first information into a first AI module to obtain second information. The communication interface is configured to send the second information to a second device, where the second information is used for being inputted into a second AI module by the second device to obtain first information and/or related information of the first information; where before the first AI module and the second AI module perform a first action, the first device and the second device align third information; where the third information includes model information of the first AI module and/or the second AI module, and the first action includes at least one of the following: training, updating, and inference. The UE embodiment corresponds to the foregoing first device side method embodiment, and the implementation processes and implementations of the foregoing method embodiments can be applied to the UE embodiments, with the same technical effects achieved.

An embodiment of this application further provides UE, including a processor and a communication interface, where the communication interface is configured to receive second information from a first device, where the second information is information obtained by the first device by inputting first information into a first AI module; and the processor is configured to input the second information into a second AI module to obtain the first information and/or related information of the first information; where before the first AI module and the second AI module perform a first action, the first device and the second device align third information; where the third information includes model information of the first AI module and/or the second AI module, and the first action includes at least one of the following: training, updating, and inference. The UE embodiment corresponds to the foregoing second device side method embodiment, and the implementation processes and implementations of the foregoing method embodiments can be applied to the UE embodiments, with the same technical effects achieved.

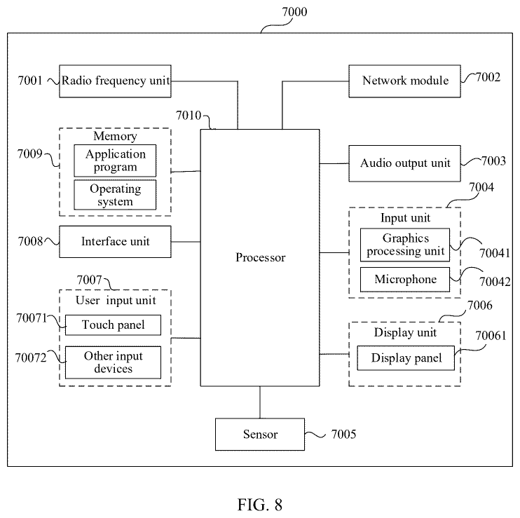

For example, FIG. 8 is a schematic diagram of a hardware structure of UE implementing an embodiment of this application.

The UE 7000 includes but is not limited to at least part of components such as a radio frequency unit 7001, a network module 7002, an audio output unit 7003, an input unit 7004, a sensor 7005, a display unit 7006, a user input unit 7007, an interface unit 7008, a memory 7009, and a processor 7010.

A person skilled in the art may understand that the UE 7000 may further include a power supply (such as a battery) for supplying power to the components. The power supply may be logically connected to the processor 7010 through a power management system. In this way, functions such as charge management, discharge management, and power consumption management are implemented by using the power management system. The structure of the UE shown in FIG. 8 does not constitute a limitation on the UE. The UE may include more or fewer components than those shown in the figure, or some components are combined, or component arrangements are different. Details are not described herein again.

It can be understood that in this embodiment of this application, the input unit 7004 may include a Graphics Processing Unit (GPU) 70041 and a microphone 70042. The graphics processing unit 70041 processes image data of a still picture or video obtained by an image capture apparatus (such as a camera) in a video capture mode or an image capture mode. The display unit 7006 may include the display panel 70061. The display panel 70061 may be configured in a form of a liquid crystal display, an organic light-emitting diode, or the like. The user input unit 7007 includes at least one of a touch panel 70071 and other input devices 70072. The touch panel 70071 is also referred to as a touchscreen. The touch panel 70071 may include two parts: a touch detection apparatus and a touch controller. The other input devices 70072 may include but are not limited to at least one of a physical keyboard, a functional button (such as a volume control button or a power on/off button), a trackball, a mouse, and a joystick. Details are not described herein.

In this embodiment of this application, after receiving downlink data from a network-side device, the radio frequency unit 7001 sends the downlink data to the processor 7010 for processing; and the radio frequency unit 7001 also sends uplink data to the network-side device. Generally, the radio frequency unit 7001 includes, but is not limited to, an antenna, an amplifier, a transceiver, a coupler, a low noise amplifier, a duplexer, and the like.

The memory 7009 may be configured to store software programs or instructions and various data. The memory 7009 may mainly include a first storage area for storing programs or instructions and a second storage area for storing data, where the first storage area may store an operating system, an application program or instructions required by at least one function (for example, an audio playing function and an image playing function), and the like. In addition, the memory 7009 may be a volatile memory or a non-volatile memory, or the memory 7009 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), Synchronous DRAM (SDRAM), a Double Data Rate SDRAM (DDRSDRAM), an Enhanced SDRAM (ESDRAM), a synchronous link dynamic random access memory (Synch link DRAM (SLDRAM)), and a direct memory bus random access memory (Direct Rambus RAM (DRRAM)). The memory 7009 described in this embodiment this application includes but is not limited to these and any other suitable types of memories.

The processor 7010 may include one or more processing units. For example, the processor 7010 integrates an application processor and a modem processor. The application processor mainly processes operations related to an operating system, a user interface, an application program, and the like. The modem processor mainly processes wireless communication signals, for example, a baseband processor. In some embodiments, it should be understood that, the modem processor may not be integrated into the processor 7010.

The processor 7010 is configured to first information into a first AI module to obtain second information. The radio frequency unit 7001 is configured to send the second information to a second device, where the second information is used for being inputted into a second AI module by the second device to obtain first information and/or related information of the first information; where before the first AI module and the second AI module perform a first action, the first device and the second device align third information; where the third information includes model information of the first AI module and/or the second AI module, and the first action includes at least one of the following: training, updating, and inference.

According to the UE in this embodiment of this application, the model related information of the first AI module and/or the second AI module is aligned in advance before training, updating, and/or inference performed by the first AI module and the second AI module. In this way, joint inference can be performed on information for the model distributed in different nodes, that is, when the UE performs inference on the first information by using the first AI module and the second device performs inference on the second information by using the second AI module, all details of the models do not need to be informed to the target node for joint inference, thereby ensuring the inference performance of the model and avoiding leakage of model information.

The UE provided in this embodiment of this application can implement the processes implemented by the first device in the foregoing method embodiment, with the same technical effects achieved. To avoid repetition, details are not described herein again.

In some embodiments, the radio frequency unit 7001 is configured to receive second information from a first device, where the second information is information obtained by the first device by inputting first information into a first AI module; and the processor 7010 is configured to input the second information into a second AI module to obtain the first information and/or related information of the first information; where before the first AI module and the second AI module perform a first action, the first device and the second device align third information; where the third information includes model information of the first AI module and/or the second AI module, and the first action includes at least one of the following: training, updating, and inference.

According to the UE in this embodiment of this application, the model related information of the first AI module and/or the second AI module is aligned in advance before training, updating, and/or inference performed by the first AI module and the second AI module. In this way, joint inference can be performed on information for the model distributed in different nodes, that is, when the first device performs inference on the first information by using the first AI module and the UE performs inference on the second information by using the second AI module, all details of the models do not need to be informed to the target node for joint inference, thereby ensuring the inference performance of the model and avoiding leakage of model information.

The UE provided in this embodiment of this application can implement the processes implemented by the second device in the foregoing method embodiment, with the same technical effects achieved. To avoid repetition, details are not described herein again.

An embodiment of this application further provides a network-side device, including a processor and a communication interface. The processor is configured to first information into a first AI module to obtain second information. The communication interface is configured to send the second information to a second device, where the second information is used for being inputted into a second AI module by the second device to obtain first information and/or related information of the first information; where before the first AI module and the second AI module perform a first action, the first device and the second device align third information; where the third information includes model information of the first AI module and/or the second AI module, and the first action includes at least one of the following: training, updating, and inference. The network-side device embodiment corresponds to the foregoing first device method embodiment, and the implementation processes and implementations of the foregoing method embodiments can be applied to the network-side device embodiments, with the same technical effects achieved.

An embodiment of this application further provides a network-side device, including a processor and a communication interface, where the communication interface is configured to receive second information from a first device, where the second information is information obtained by the first device by inputting first information into a first AI module; and the processor is configured to input the second information into a second AI module to obtain the first information and/or related information of the first information; where before the first AI module and the second AI module perform a first action, the first device and the second device align third information; where the third information includes model information of the first AI module and/or the second AI module, and the first action includes at least one of the following: training, updating, and inference. The network-side device embodiment corresponds to the foregoing second device method embodiment, and the implementation processes and implementations of the foregoing method embodiments can be applied to the network-side device embodiments, with the same technical effects achieved.

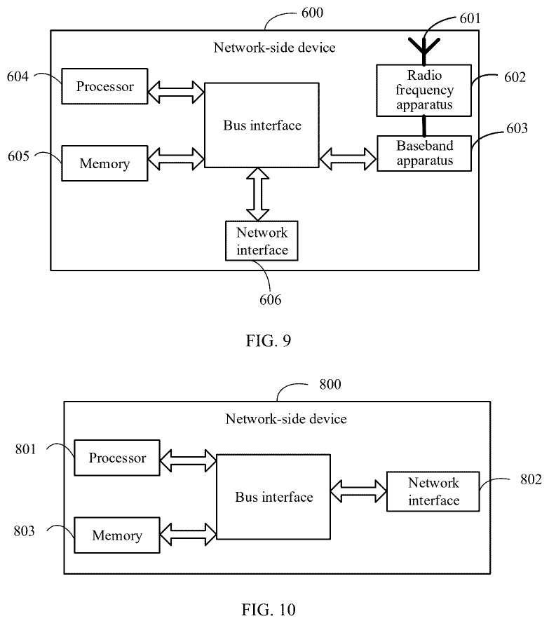

For example, an embodiment of this application further provides a network-side device. As shown in FIG. 9, the network-side device 600 includes an antenna 601, a radio frequency apparatus 602, a baseband apparatus 603, a processor 604, and a memory 605. The antenna 601 is connected to the radio frequency apparatus 602. In an uplink direction, the radio frequency apparatus 602 receives information by using the antenna 601, and sends the received information to the baseband apparatus 603 for processing. In a downlink direction, the baseband apparatus 603 processes to-be-sent information, and sends the information to the radio frequency apparatus 602; and the radio frequency apparatus 602 processes the received information and then sends the information out by using the antenna 601.

The method performed by the network-side device in the foregoing embodiment may be implemented in the baseband apparatus 603, and the baseband apparatus 603 includes a baseband processor.

The processor 604 is configured to first information into a first AI module to obtain second information. The radio frequency apparatus 602 is configured to send the second information to a second device, where the second information is used for being inputted into a second AI module by the second device to obtain first information and/or related information of the first information; where before the first AI module and the second AI module perform a first action, the first device and the second device align third information; where the third information includes model information of the first AI module and/or the second AI module, and the first action includes at least one of the following: training, updating, and inference.

According to the network-side device in this embodiment of this application, the model related information of the first AI module and/or the second AI module is aligned in advance before training, updating, and/or inference performed by the first AI module and the second AI module. In this way, joint inference can be performed on information for the model distributed in different nodes, that is, when the network-side device performs inference on the first information by using the first AI module and the second device performs inference on the second information by using the second AI module, all details of the models do not need to be informed to the target node for joint inference, thereby ensuring the inference performance of the model and avoiding leakage of model information.

The network-side device provided in this embodiment of this application can implement the processes implemented by the first device in the foregoing method embodiment, with the same technical effects achieved. To avoid repetition, details are not described herein again.

In some embodiments, the radio frequency apparatus 602 is configured to receive second information from a first device, where the second information is information obtained by the first device by inputting first information into a first AI module; and the processor 604 is configured to input the second information into a second AI module to obtain the first information and/or related information of the first information; where before the first AI module and the second AI module perform a first action, the first device and the second device align third information; where the third information includes model information of the first AI module and/or the second AI module, and the first action includes at least one of the following: training, updating, and inference.

According to the network-side device in this embodiment of this application, the model related information of the first AI module and/or the second AI module is aligned in advance before training, updating, and/or inference performed by the first AI module and the second AI module. In this way, joint inference can be performed on information for the model distributed in different nodes, that is, when the first device performs inference on the first information by using the first AI module and the network-side device performs inference on the second information by using the second AI module, all details of the models do not need to be informed to the target node for joint inference, thereby ensuring the inference performance of the model and avoiding leakage of model information.

The network-side device provided in this embodiment of this application can implement the processes implemented by the second device in the foregoing method embodiment, with the same technical effects achieved. To avoid repetition, details are not described herein again.

The baseband apparatus 603 may include, for example, at least one baseband processing unit, where a plurality of chips are disposed on the baseband processing unit. As shown in FIG. 9, one of the chips is, for example, the baseband processor, and connected to the memory 605 through a bus interface, to invoke the program in the memory 605 to perform the operations of the network device shown in the foregoing method embodiment.

The network-side device may further include a network interface 606, where the interface is, for example, a common public radio interface (CPRI).

For example, the network-side device 600 according to this embodiment of this application further includes instructions or programs stored in the memory 605 and capable of running on the processor 604, and the processor 604 calls the instructions or programs in the memory 605 to execute the methods performed by the modules, with the same technical effects achieved. To avoid repetition, details are not described herein again.

For example, an embodiment of this application further provides a network-side device. As shown in FIG. 10, the network-side device 800 includes a processor 801, a network interface 802, and a memory 803. The network interface 802 is, for example, a CPRI.

For example, the network-side device 800 according to this embodiment of the present disclosure further includes instructions or programs stored in the memory 803 and capable of running on the processor 801, and the processor 801 calls the instructions or programs in the memory 803 to execute the methods performed by the modules, with the same technical effects achieved. To avoid repetition, details are not described herein again.

An embodiment of this application further provides a readable storage medium. The readable storage medium stores a program or instructions. When the program or instructions are executed by a processor, the processes of the foregoing embodiments of the information transmission method are implemented, with the same technical effects achieved. To avoid repetition, details are not described herein again.

The processor is the processor in the communication device in the foregoing embodiment. The readable storage medium includes computer readable storage medium, such as computer read-only memory ROM, random access memory RAM, magnetic disk, or optical disc.

An embodiment of this application further provides a chip. The chip includes a processor and a communication interface. The communication interface is coupled to the processor. The processor is configured to run a program or instructions to implement each process of the foregoing method embodiment, with the same technical effects achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program/program product, where the computer program/program product is stored in a storage medium, and when being executed by at least one processor, the computer program/program product is configured to implement the processes of the foregoing embodiments of the method, with the same technical effects achieved. To avoid repetition, details are not repeated herein.

An embodiment of this application further provides a communication system, including a first device and a second device, where the first device can be configured to execute the steps of the information transmission method embodiment, and the second device can be configured to execute the steps of the information transmission method embodiment.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

By means of the foregoing description of the implementations, persons skilled in the art may clearly understand that the method in the foregoing embodiment may be implemented by software with a necessary general hardware platform. The method in the foregoing embodiment may also be implemented by hardware. However, in many cases, the former is an example implementation. Based on such an understanding, the technical solutions of the present disclosure essentially or the part contributing to the prior art may be implemented in a form of a computer software product. The software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this disclosure.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. An information transmission method, comprising:
inputting, by a first device, first information into a first Artificial Intelligence (AI) module to obtain second information; and
sending, by the first device, the second information to a second device, wherein the second information is used for inputting the second information into a second AI module by the second device to obtain at least one of the first information or related information of the first information; wherein
before the first AI module and the second AI module perform a first action, the first device and the second device align third information; wherein the third information comprises model information of at least one of the first AI module or the second AI module, and the first action comprises at least one of the following: training, updating, or inference.

2. The information transmission method according to claim 1, wherein the first information comprises at least one of the following: channel information or beam quality information; and
the second information comprises at least one of the following: a Precoding Matrix Indicator (PMI), or predicted beam information or beam indication,
or
wherein at least one of the first AI module or the second AI module is obtained based on at least one of the following:
being obtained through training by the first device based on target information from the second device or other network elements; or
being obtained through training by the second device based on target information from the first device or other network elements,
or
wherein at least one of the first AI module or the second AI module is updated or adjusted according to at least one of the following:
performing updating or adjustment by the first device based on the target information from the second device or other network elements; or
performing updating or adjustment by the second device based on the target information from the first device or other network elements; wherein
the target information comprises at least one first information related to the first action of the AI module and at least one second information corresponding to the at least one first information.

3. The information transmission method according to claim 1, wherein the third information comprises at least one of the following: a structural feature of a model, a payload quantization method of the model, or estimation accuracy or output accuracy of the model.

4. The information transmission method according to claim 3, wherein the structural features of the model comprise at least one of the following: a model structure, a basic structural feature of the model, a structural feature of a model sub-module, a number of model layers, a number of neurons in the model, a model size, model complexity, or a quantization parameter of a model parameter, or
wherein the payload quantization method comprises at least one of the following: a quantization mode, dimensions of features before and after quantization, or a quantization method used during quantization.

5. The information transmission method according to claim 4, wherein the basic structural feature of the model comprises at least one of the following: whether a fully connected structure is comprised, whether a convolution structure is comprised, whether a long short-term memory model LSTM structure is comprised, whether an attention structure is comprised, or whether a residual structure is comprised,
or
wherein the number of neurons in the model comprises at least one of the following: a number of fully connected neurons, a number of convolution neurons, a number of memory neurons, a number of attention neurons, or a number of residual neurons; or
the number of neurons in the model comprises at least one of the following: a number of neurons of all types, a number of neurons of a single type, a number of neurons of an entire model, or a number of neurons of a single layer or several layers,
or
wherein the quantization parameter of the model parameter comprises at least one of the following: a quantization mode of the model parameter or a number of quantization bits of a single neuron parameter; or
the quantization mode of the model parameter comprises at least one of the following: a uniform quantization mode, a non-uniform quantization mode, a weight sharing quantization mode or grouping quantization mode, a parameter coding quantization mode, a transform domain quantization mode, or a product quantization mode.

6. The information transmission method according to claim 5, wherein the quantization method used during quantization comprises at least one of the following: codebook content and a codebook usage method need to be synchronized when a codebook is used for quantization, or a quantization rule needs to be synchronized when a specific rule is used for quantization.

7. The information transmission method according to claim 6, wherein the quantization rule comprises at least one of the following: N quantization ranges, or a quantization mode, wherein N is a positive integer; and
the quantization mode comprises at least one of the following: a uniform quantization mode, a non-uniform quantization mode, a weight sharing quantization mode or grouping quantization mode, a parameter coding quantization mode, a transform domain quantization mode, or a product quantization mode,
or
wherein at least one of during synchronization of the codebook content and the codebook usage method or during synchronization of the quantization rule, the synchronization method comprises any one of the following: selecting a set number representing a selected method for feedback during synchronization from a predefined set of methods, or directly sending the codebook content.

8. The information transmission method according to claim 1, wherein a manner of aligning the third information by the first device and the second device comprises at least one of the following:
the first device or other network elements simultaneously send the third information when sending target information to the second device;
the second device or other network elements simultaneously send the third information when sending target information to the first device;
the first device or other network elements send the third information before the first device or other network elements send the target information to the second device;
the second device or other network elements send the third information before the second device or other network elements send the target information to the first device;
the second device sends the third information when the second device requests the target information;
the first device sends the third information when the first device requests the target information;
the first device or other network elements send acknowledgment information and send the third information when the second device requests the target information, wherein the acknowledgment information is used to indicate that a request of the second device is agreed;
or
the second device or other network elements send acknowledgment information and send the third information when the first device requests the target information, wherein the acknowledgment information is used to indicate that a request of the first device is agreed;
wherein
the target information comprises at least one first information related to the first action of the AI module and at least one second information corresponding to the at least one first information,
or
wherein a manner of aligning the third information by the first device and the second device comprises at least one of the following:
after a device receiving the third information sends acknowledgment information for the third information, at least one of the first AI module or the second AI module uses a model associated with the third information;
after a device receiving the third information sends acknowledgment information for the third information and a first duration elapses, at least one of the first AI module or the second AI module uses a model associated with the third information; or
after a first duration following a sending time or receiving time of the third information elapses, at least one of the first AI module or the second AI module uses a model associated with the third information;
wherein the first duration is determined based on any one of the following: being carried by the third information, being carried by the acknowledgment information for the third information, being carried by other associated information or signaling of the third information, being specified by a protocol, or being determined based on a capability of the first device or the second device.

9. The information transmission method according to claim 8, wherein the second device or the other network elements send the target information after the first device sends acknowledgment information for the third information, or
the first device or the other network elements send the target information after the second device sends acknowledgment information for the third information.

10. An information transmission method, comprising:
receiving, by a second device, second information from a first device, wherein the second information is information obtained by the first device by inputting first information into a first artificial intelligence Artificial Intelligence (AI) module; and
inputting, by the second device, the second information into a second AI module to obtain at least one of the first information or related information of the first information; wherein
before the first AI module and the second AI module perform a first action, the first device and the second device align third information; wherein the third information comprises model information of at least one of the first AI module or the second AI module, and the first action comprises at least one of the following: training, updating, or inference.

11. The information transmission method according to claim 10, wherein the first information comprises at least one of the following: channel information or beam quality information; and
the second information comprises at least one of the following: a Precoding Matrix Indicator (PMI), or predicted beam information or beam indication,
or
wherein at least one of the first AI module or the second AI module is obtained based on at least one of the following:
being obtained through training by the first device based on target information from the second device or other network elements; or
being obtained through training by the second device based on target information from the first device or other network elements,
or
wherein at least one of the first AI module or the second AI module is updated or adjusted according to at least one of the following:
performing updating or adjustment by the first device based on the target information from the second device or other network elements; or
performing updating or adjustment by the second device based on the target information from the first device or other network elements; wherein
the target information comprises at least one first information related to the first action of the AI module and at least one second information corresponding to the at least one first information.

12. The information transmission method according to claim 10, wherein the third information comprises at least one of the following: a structural feature of a model, a payload quantization method of the model, or estimation accuracy or output accuracy of the model.

13. The information transmission method according to claim 12, wherein the structural features of the model comprise at least one of the following: a model structure, a basic structural feature of the model, a structural feature of a model sub-module, a number of model layers, a number of neurons in the model, a model size, model complexity, or a quantization parameter of a model parameter, or
wherein the payload quantization method comprises at least one of the following: a quantization mode, dimensions of features before and after quantization, or a quantization method used during quantization.

14. The information transmission method according to claim 10, wherein a manner of aligning the third information by the first device and the second device comprises at least one of the following:
the first device or other network elements simultaneously send the third information when sending target information to the second device;
the second device or other network elements simultaneously send the third information when sending target information to the first device;
the first device or other network elements send the third information before the first device or other network elements send the target information to the second device;
the second device or other network elements send the third information before the second device or other network elements send the target information to the first device;
the second device sends the third information when the second device requests the target information;
the first device sends the third information when the first device requests the target information;
the first device or other network elements send acknowledgment information and send the third information when the second device requests the target information, wherein the acknowledgment information is used to indicate that a request of the second device is agreed; or
the second device or other network elements send acknowledgment information and send the third information when the first device requests the target information, wherein the acknowledgment information is used to indicate that a request of the first device is agreed, wherein
the target information comprises at least one first information related to the first action of the AI module and at least one second information corresponding to the at least one first information.

15. The information transmission method according to claim 10, wherein a manner of aligning the third information by the first device and the second device comprises at least one of the following:
after a device receiving the third information sends acknowledgment information for the third information, at least one of the first AI module or the second AI module uses a model associated with the third information;
after a device receiving the third information sends acknowledgment information for the third information and a first duration elapses, at least one of the first AI module or the second AI module uses a model associated with the third information; or
after a first duration following a sending time or receiving time of the third information elapses, at least one of the first AI module or the second AI module uses a model associated with the third information.

16. A communication device, comprising a processor and a memory storing instructions, wherein the instructions, when executed by the processor, cause the processor to perform operations comprising:
inputting first information into a first Artificial Intelligence (AI) module to obtain second information; and
sending the second information to a second device, wherein the second information is used for inputting the second information into a second AI module by the second device to obtain at least one of the first information or related information of the first information; wherein
before the first AI module and the second AI module perform a first action, the first device and the second device align third information; wherein the third information comprises model information of at least one of the first AI module or the second AI module, and the first action comprises at least one of the following: training, updating, or inference.

17. The communication device according to claim 16, wherein the first information comprises at least one of the following: channel information or beam quality information; and
the second information comprises at least one of the following: a Precoding Matrix Indicator (PMI), or predicted beam information or beam indication,
or
wherein at least one of the first AI module or the second AI module is obtained based on at least one of the following:
being obtained through training by the first device based on target information from the second device or other network elements; or
being obtained through training by the second device based on target information from the first device or other network elements,
or
wherein at least one of the first AI module or the second AI module is updated or adjusted according to at least one of the following:
performing updating or adjustment by the first device based on the target information from the second device or other network elements; or
performing updating or adjustment by the second device based on the target information from the first device or other network elements; wherein
the target information comprises at least one first information related to the first action of the AI module and at least one second information corresponding to the at least one first information.

18. A communication device, comprising a processor and a memory storing instructions, wherein the instructions, when executed by the processor, cause the processor to perform the information transmission method according to claim 10.

19. A non-transitory computer-readable storage medium storing instructions that, when executed by a processor of a first device, cause the processor to perform the information transmission method according to claim 1.

20. A non-transitory computer-readable storage medium storing instructions that, when executed by a processor of a second device, cause the processor to perform the information transmission method according to claim 10.
